(19) United States
(12) Patent Application Publication
(10) Pub. No.: US 2007/0124153 A1
(43) Pub. Date: May 31, 2007

(54) Method for eliminating a follow up action for an electronically delivered document

(75) Inventor: Alan Fendrick, Rumson, NJ (US)

Correspondence Address: RAYMOND R. MOSER JR., ESQ.;MOSER IP LAW GROUP, 1040 BROAD STREET, 2ND FLOOR, SHREWSBURY, NJ, 07702, US

(73) Assignee: Millenium Consulting Council, Inc.

(21) Appl. No.: 11/287,635

(22) Filed: Nov. 28, 2005

(51) Int. Cl. G06Q 99/00

(52) U.S. Cl. 705/1

(57) ABSTRACT

Embodiments of the invention provide a method for eliminating a follow-up action regarding an electronically sent document. The method includes embedding a follow-up action elimination button into an electronic document, transmitting the electronic document from a first computer to a second computer through a network, displaying the follow-up action elimination button using the second computer, and upon manipulation of the follow-up elimination button, establishing a selection indicia within a database of the first computer that eliminates a follow-up action.

### BACKGROUND OF THE INVENTION

1. Field of the Invention

Embodiments of the present invention generally relate to a method for processing electronically sent documents, and more particularly, a method for eliminating any follow-up actions that are taken in view of delivery of an online communication.

2. Description of the Related Art

The development and vast acceptance of the Internet in the industrialized nations has had a substantial impact on essentially every aspect of commerce in these nations. Businesses are able to buy and sell goods and services through online portals with substantially reduced overhead costs, communicate instantaneously through e-mail and/or online messaging systems, pay and receive payment for goods and services through online payment systems, etc. Consumers have obviously benefited from these types of advancements, as consumers are able to purchase products online at reduced prices, pay bills online, and the like.

Although the transition of commerce to Internet based systems has been a great advancement for both businesses and individuals, there are still several areas where further commitment and reliance upon electronic commerce methods is needed. For example, nearly every person in the industrialized nations has a credit card, a stock brokerage account, or any number of other items for which they receive constant information. Very few people pay their bills through an online method, e.g., an online bill pay service or through direct payment to the company. Although many of these people pay their credit card bill online, the credit card companies still send each of their customers a printed statement/bill each billing cycle. As such, the full benefit of an electronic bill payment system is far from being realized, as thousands of tons of paper are wasted each year sending redundant statements to customers, i.e., statements that have already been paid by the customer. This same comment is applicable to virtually every business that wishes to send their documents electronically (which is virtually every business) in that they are currently forced to send the electronic AND follow it up with a paper copy, not only mitigating any savings—but in fact adding cost to the “old” method of just sending paper. As such, there is a need for an improved method for sending online documents to end users that eliminates the delivery of any follow-up documents (e.g., a paper statement).

### SUMMARY OF THE INVENTION

Embodiments of the invention provide a method for eliminating a follow-up action in view of delivery of documents using electronic communications. The method includes sending an electronic document to an end user, while providing the user, in the same document, the ability to eliminate a follow up action such as transmission of a subsequent paper copy representative of the document that has been electronically delivered. The default condition, upon sending a document electronically, is to send the paper copy unless the user affirmatively requests that the document not be sent. The end user determines whether the paper copy of the document is sent via the mail or not. In this manner, a user may eliminate the follow-up action that will otherwise occur regarding the electronically delivered document.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary network fabric configured to conduct the method of the invention.

FIG. 2 illustrates a flowchart of an exemplary method of the invention.

FIG. 3 illustrates an exemplary electronic document of the invention having a document delivery control embedded therein.

### DETAILED DESCRIPTION

The present invention provides an online document delivery control method that enables a user to eliminate a follow up action after receiving an electronic document. Exemplary follow up actions include sending paper documents through the mail, follow up telephone calls and the like. The invention is useful for financial and billing communications, wherein the method selectively controls redundant paper document transmission through regular mail. The method generally includes sending an electronic document of any type to an end user. The method provides the user, in the same document, with the ability to decline a subsequent paper copy representative of the electronic document is sent to the user.

In the following, reference is made to embodiments of the invention, however, it should be understood that the inventors do not intend for the invention to be limited to any of the specifically described embodiments. Rather, the inventors intend that any combination of the following features and elements, whether related to different embodiments or not, is contemplated to implement and practice the invention. Furthermore, various embodiments the invention provide numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

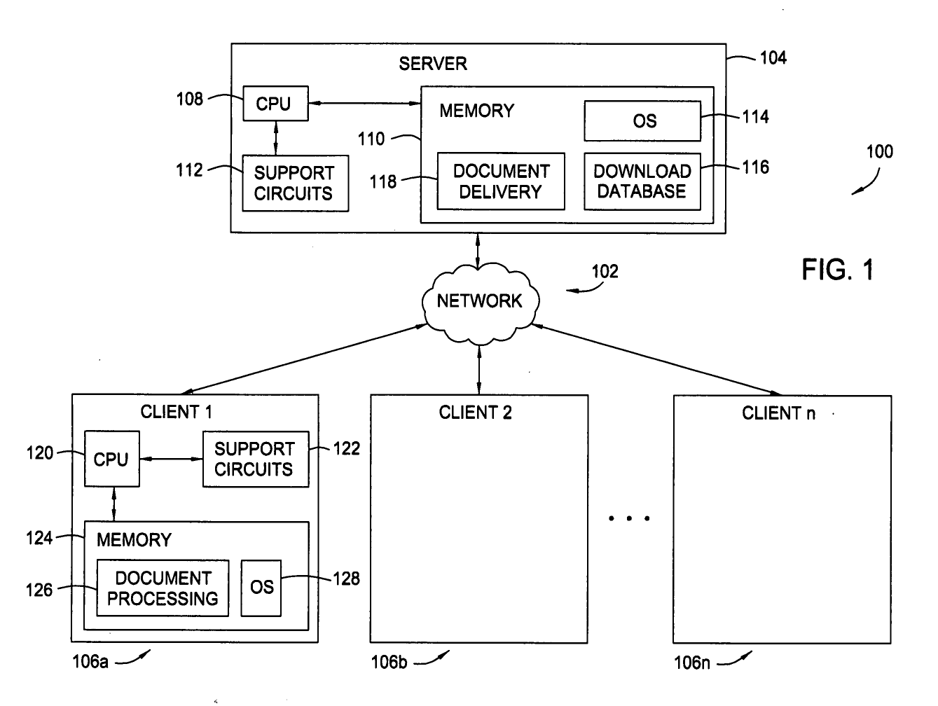

One embodiment of the invention is implemented as a program product for use with a computer system such as, for example, the network fabric 100 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 illustrates an exemplary network fabric 100 configured to conduct one embodiment of the method of the invention. The network fabric 100 generally includes a network backbone 102 that is in communication with a plurality of client stations 106a, 106b, . . . 106n (collectively referred to as client stations 106) and at least one computer server 104. In this configuration, the computer server 104 is in bidirectional communication with each of the client stations 106 through the network backbone 102. The network fabric 100 may include an internet (e.g., the Internet), intranet, a wireless network, or any other distributed computing environment. The invention does not rely on any specific means for delivery of electronic documents. As such, any form of communications network or delivery mechanism may be used.

The computer server 104 generally includes a central processing unit (CPU) that is in bidirectional communication with a memory unit 110 through, for example, a server bus (not shown). The memory unit 110 is generally configured to store data and program files needed to support the method of the invention. The memory unit 110 includes an operating system (OS), which is generally known as software that controls the execution of computer programs and may provide various core computing services. The memory unit 110 also includes a download database 116 configured to store data related to the method of the invention, as will be further described herein. The memory unit 110 further includes a document delivery memory configured to store data related to the method of the invention, as will be further described herein. Although each of the elements within memory 110 is illustrated as separate and individual elements, embodiments of the invention do not require this configuration. For example, memory unit 110 may be a unitary memory unit, such as a hard disk drive or other common computer memory source, that has been partitioned or otherwise divided into sections or locations that allow for organized storage of data and program files.

The memory unit 110 is in bidirectional communication with the CPU 108, which generally means that the CPU may both read from memory unit 110 and write to memory unit 110. The CPU 108 is also in bidirectional communication with support circuitry 112, which generally constitutes the electronic circuitry necessary for the CPU 108 and memory unit 110 combination to communicate with each other and with devices external to the computer server 104. Exemplary support circuitries include modems, network cards, computer ports, interfaces, and the like.

Each of the dient stations 106 also generally includes a CPU 120 and a memory unit 124 that are in bidirectional communication with each other through, for example, as client system bus (not shown). The memory unit 124 generally includes an OS 128 and document processing memory portion 126. The CPU is also in bidirectional communication with support circuitry 122, which generally constitutes the electronic circuitry necessary for the CPU 120 and memory unit 124 to communicate with each other and with devices external to the computer server client station 106. In one embodiment of the invention, the client station 106 comprises a personal computer having a network card or modem that allows the personal computer to connect to an Internet access network that is capable of communicating with a remotely located computer server.

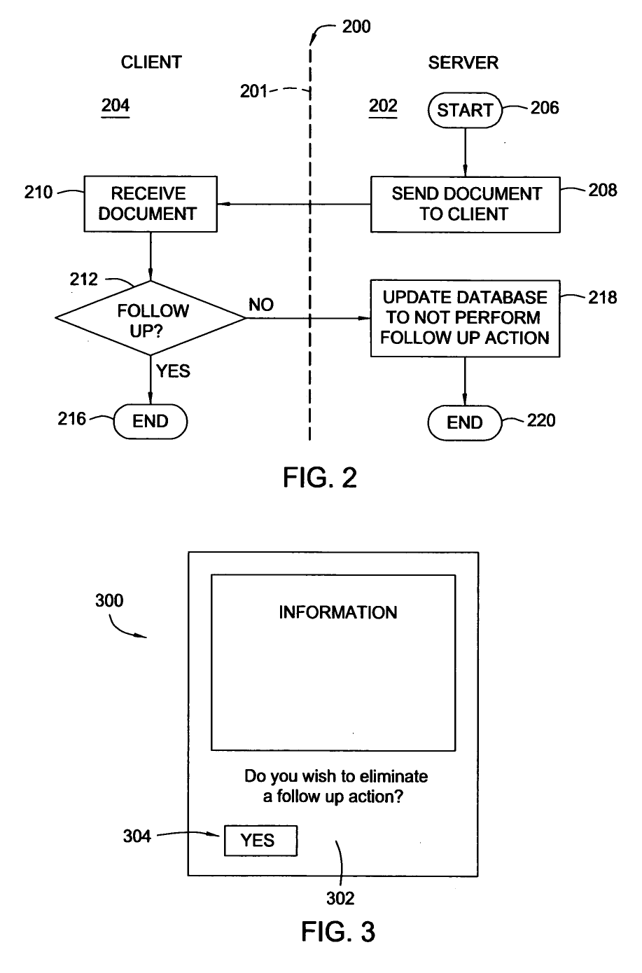

FIG. 2 illustrates a flowchart of an exemplary method 200 of the invention. The exemplary method illustrated in FIG. 2 shows the method steps for both the client computer 106 and the server computer 104. The method steps for the server computer 104 are illustrated on one side 202 of the flowchart and the method steps for the client computer 106 are shown on the opposing side 204 of the flowchart, and the dashed line 201 separates the steps processed on the client side 204 from the server side 202.

Although the embodiment discussed herein shows the “sender” of documents as a server and a ”recipient” of the documents as a client, the invention may also be used to provide client-to-client document control, server-to-server document control, or any combination there of.

The exemplary method begins at step 206 and continues to step 208, where the server computer 104 sends an electronic document 300, as illustrated in FIG. 3, to the client computer 106. The electronic document 300 may be essentially any form of electronic communication, including, but not limited to electronic bank or credit card statements, bills, letters, product orders, invoices, airline tickets or confirmations, hotel reservations or confirmations, advertisements, promotional offers, invitations, travel other membership statements, e-mail, or any other form of communication where the recipient may desire to eliminate a follow-up action such as to receive a subsequent communications related to the electronic document after reading the electronic version of the communication. The electronic document 300 sent by the server computer 104 includes a follow-up action elimination section 302 embedded therein. The section 302 comprises at least one button 304 that enables the user to decline (or otherwise eliminate) a follow-up action such as the delivery of a follow-up document. This button represents a “link” to a sender's database. The database may be updated depending upon the manipulation of the button by the user.

The electronic document 300 is received by the client computer 106 at step 210.

In the present embodiment, for example, the electronic document 300 sent to the client computer 106 may comprise a credit card statement or bill, and the delivery option 302 may, for example, be a button or link 304 embedded in the electronically sent credit card statement or bill. The embedded button or link 304 generally provides the user with an option or selection related to the electronic document (the electronically sent bill). The button or link 304 embedded in the electronic document 300 offers the user the option to decline a follow-up action such as mailing of a subsequent paper document.

In one embodiment of the invention, the default mode automatically sends a paper copy unless a single button is selected to eliminate the transmission of a paper copy. In another embodiment the default mode may be to not send a paper copy unless a single button is selected to request the transmission of a paper copy. In short, under a default scenario, a particular follow-up action will occur unless an affirmative selection is made by the user to establish indicia of change for the default.

In FIG. 3, if the user eliminates a follow-up action by selecting button 304, the method 200 proceeds to step 218 wherein the database within the server is updated to indicate that no follow-up action is to be taken, e.g., a paper copy is not to be sent to the user. The method 200 ends at step 220. If the user does not decline, the method ends at step 216.

The method of the invention may be used in multiple embodiments. For example, as briefly noted above, the electronic document may be a credit card billing statement, and the button or link in the statement may be used to acknowledge receipt of the statement so that the credit card company does not have to send a subsequent paper statement.

In another embodiment of the invention, the electronic document may be another type of statement or communication where the button or link embedded in the document is shown before the reader ever sees the body of the electronic document. In this embodiment, the button may be used to acknowledge reading the electronic document or to accept the server sending the body of the document to the user for review. A second button may be used to confirm receipt of the body of the electronic document and decline a follow up document.

In other embodiments, an electronic mail or web page may have an embedded button that enables a user to request a download of an electronic document without a paper copy to follow.

In each embodiment above, when a button or link is selected by the user, then an electronic communication may be sent to the server computer 104 indicating the selection. This communication allows the server computer 104 to track the sequence of events related to the electronic document and the embedded buttons or links. In other words, when a button is selected indicia of selection is sent from the client through the network to the server.

In one alternative use of the invention, an e-mail invitation or notice may be sent to a user and the user may select a button that indicates that the e-mail was received (or otherwise acknowledged). A database at the sender's location is automatically updated with the acknowledgement and a follow-up action does not occur. This technique is useful, for example, when a coach is contacting parents about a game cancellation via e-mail. The coach may send e-mail with at least one acknowledgement button. For each parent that acknowledges receipt of the original notification, a follow-up phone call is unnecessary. Such an acknowledgement technique has many uses.

While the foregoing is directed to embodiments of the present invention, other and further embodiments of the invention may be devised without departing from the basic scope thereof, and the scope thereof is determined by the claims that follow.

1. A method for eliminating a follow up action in response to delivery of an electronic document, comprising:
embedding a follow-up elimination button into an electronic document;
transmitting the electronic document from a first computer to a second computer through a network;
displaying the electronic document using the second computer; and
upon manipulation of the follow-up elimination button, establishing a selection indicia within a database of the first computer that eliminates a follow-up action.

2. The method of claim 1 wherein the follow-up action is delivery of a paper copy of the electronic document.

3. The method of claim 1 wherein the follow-up action is delivery of additional information related to the electronic document.

4. The method of claim 1 wherein the follow-up action is a phone call.

5. The method of claim 1, further comprising:
updating a download database within the first computer with the selection indicia.

6. The method of claim 5 wherein the selection indicia alters a default follow-up action.

7. A method for eliminating a follow up action in response to delivery of an electronic document, comprising:
embedding a document delivery elimination button into an electronic document;
transmitting the electronic document from a first computer to a second computer through a network;
displaying the electronic document using the second computer; and
upon manipulation of the document delivery elimination button, establishing a selection indicia within a database of the first computer that eliminates the delivery of a paper copy of the electronic document such that a paper copy shall not be delivered.

8. The method of claim 1, further comprising:
updating a download database within the first computer with the selection indicia.

9. The method of claim 5 wherein the selection indicia alters a default delivery action.
